(19) United States
(12) Patent Application Publication
(10) Pub. No.: US 2009/0301294 A1
(43) Pub. Date: Dec. 10, 2009

(54) Pressure Medium Connection and Piston-Cylinder Unit Provided Therewith

(75) Inventors: Rainer Massmann, Bonn (DE); Kathrin Peifer, Mittelstrimmig (DE); Ulrich Probst, Hillscheid (DE); Reiner Wendling, Kastellaun (DE)

Correspondence Address: COHEN, PONTANI, LIEBERMAN & PAVANE LLP, 551 FIFTH AVENUE, SUITE 1210, NEW YORK, NY, 10176, US

(73) Assignee: Stabilus GmbH, Koblenz (DE)

(21) Appl. No.: 12/479,506

(22) Filed: Jun. 5, 2009

(30) Foreign Application Priority Data
Jun. 6, 2008 (DE) 10 2008 027 226.4

(51) Int. Cl. F15B 15/14

(52) U.S. Cl. 92/169.1

(57) ABSTRACT

A pressure medium connection with a pressure connection element and a pressure line connector. The pressure connection element includes a contact surface for contacting the outside surface of a cylinder, a bore, divided into a first bore section of larger diameter and a second bore section of smaller diameter. A shoulder is formed at the transition from the first bore section to the second bore section, and two slots formed in the wall of the pressure connection element. A piston-cylinder unit, such as a hydraulic or pneumatic actuator or a hydropneumatic actuator in motor vehicles, especially for moving vehicle devices, tops, doors, hinged lids, or the like, includes the pressure medium connection.

### BACKGROUND OF THE INVENTION

1. Field of the Invention

The present invention relates to a pressure medium connection with a pressure connection element and a pressure line connector for connecting a piston-cylinder unit to a pressure medium line and also pertains to a piston-cylinder unit such as a hydraulic or pneumatic actuator or a hydropneumatic actuator in motor vehicles, especially for moving vehicle devices, tops, doors, hinged lids, or the like.

2. Description of the Related Art

A hydraulic cylinder is known from DE 195 46 695, having a cylinder on which two stud-welded pressure connection elements are arranged, which are relatively large in size and thus also occupy a relatively large amount of space, which is considered disadvantageous especially in the motor vehicle area.

EP 1 043 537 B1 describes a retaining clip for holding a pressure line connector, which clip can be inserted into the pressure connection element of a hydraulic cylinder. This clip is also large in size and comprises a relatively large space requirement.

DE 37 32 741 C2 discloses a pneumatic-hydraulic actuator, in which the pressure connection elements are designed as screw elements. These types of pressure connection elements are not suitable for working cylinders in which the cylinder executes a pivoting movement, because the screw connections can come loose, and the fluid being used can escape.

### SUMMARY OF THE INVENTION

An object of the invention is to provide a pressure medium connection for a hydraulic, pneumatic, or hydropneumatic piston-cylinder unit, which is easy and inexpensive to produce and which makes it possible to reduce the height of the connection significantly at the same time.

The object is accomplished according to one embodiment of the invention in that the pressure medium connection comprises a pressure connection element and a pressure line connector, where the pressure connection element includes:
a contact surface for contacting the outside surface of a cylinder;
a bore, divided into a first bore section of larger diameter and a second bore section of smaller diameter, where a shoulder is formed at the transition from the first bore section to the second bore section; and
two slots formed in the wall of the pressure connection element.

The object is also accomplished according to the invention by a piston-cylinder unit comprising a pressure medium connection of this type.

So that the pressure connection element can be welded easily and reliably to the cylinder, the contact surface of the pressure connection element comprises a radius which is essentially the same as the outside radius of the cylinder.

In one embodiment of the pressure medium connection, the pressure line connector comprises a hollow shaft with a first shaft section and a second shaft section.

To establish a reliable connection between the pressure connection element and the pressure line connector, the first shaft section comprises an outside diameter which is essentially the same as the inside diameter of the bore of the pressure connection element in the area of the second bore section and of the bore in the cylinder.

Preferably, the second shaft section comprises an outside diameter that is essentially the same as the inside diameter of the bore of the pressure connection element in the area of the first bore section.

In a further embodiment, a connector head follows the second shaft section. A pressure line connected to the connector head extends from the head in the radial direction.

For the pressure line connector to be connected rotatably to the pressure connection element, the second shaft section includes a radially-oriented circumferential groove in its lateral surface.

An essentially C-shaped retaining clip engages in the groove in the pressure line connector and is pushed into the slots of the pressure connection element.

So that the pressure connection element and the pressure line connector can be connected to each other in a fluid-tight manner, a sealing ring is pushed onto the first shaft section so that it lies between the shoulder and the second shaft section.

The sealing ring is preferably designed as an O-ring, which is pressed by the second shaft section against the shoulder and thus becomes pretensioned.

Alternatively, the sealing ring can be a rectangular ring, which is pushed by the pressure prevailing in the cylinder against the second shaft section.

In a further embodiment of the pressure medium connection, a radially-oriented circumferential welding seam, preferably a laser weld, surrounds the pressure connection element near the contact surface.

So that the wall of the cylinder can be made relatively thin and thus so that it can be produced relatively inexpensively, the welding seam is a welding seam created by laser welding.

To achieve very good corrosion protection, a coat of varnish is applied to the cylinder and covers the seam and at least part of the pressure connection element.

The pressure connection element is preferably made of non-corroding material and is not provided with the coat of varnish in the area of the slots.

According to the invention, a piston-cylinder unit comprises a pressure medium connection as described above.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are shown in the drawing and are described in greater detail below:

FIG. 1 is a three-dimensional perspective view of a piston-cylinder unit;

FIG. 2 is a sectional view of a detail of the embodiment shown in FIG. 1;

FIG. 3 is sectional view of another detail of the embodiment shown in FIG. 1; and

FIG. 4 is a detailed view of a retaining clip.

### DETAILED DESCRIPTION OF THE PRESENTLY PREFERRED EMBODIMENTS

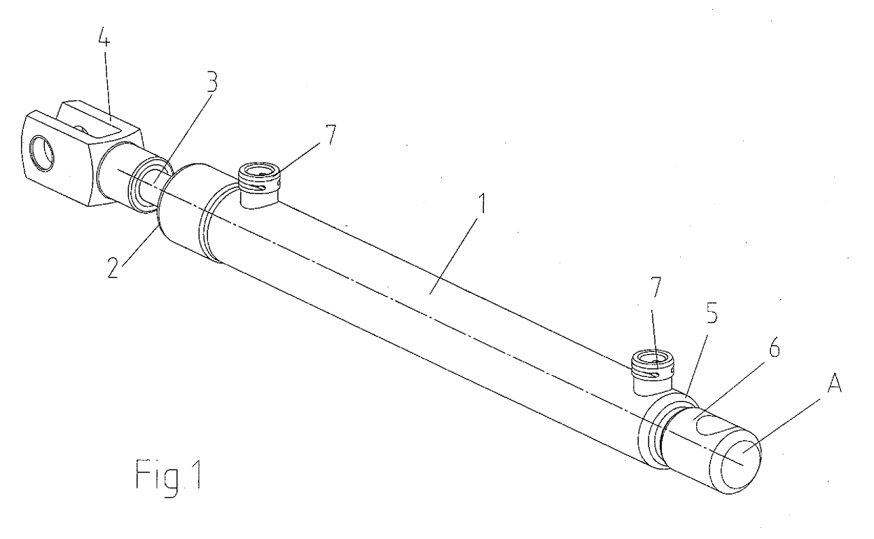

FIG. 1 shows a piston-cylinder unit as embodied by a hydraulic or pneumatic actuator or by a hydropneumatic actuator with a cylinder 1, through the first end 2 of which a piston rod 3 is guided out of the cylinder 1 in a sealed manner by means of a sealing and guide device (not shown). The end of the piston rod 3 projecting from the cylinder 1 is provided with a first mounting element 4, which is screwed, welded, or otherwise connected to the end of the piston rod 3. A second mounting element 6 is arranged on a second end 5 of the cylinder 1 opposite the first end 2.

Near the first end 2 and near the second end 5 of the cylinder 1, there is, in each case, a pressure connection element 7, via which a medium in the form of oil, such as hydraulic oil, or a gas, such as compressed air or nitrogen, can be supplied to the interior of the cylinder 1 or taken from it, so that the piston rod 3 can be moved back and forth along the central longitudinal axis A by a piston (not shown), which divides the interior of the cylinder 1 into two working chambers.

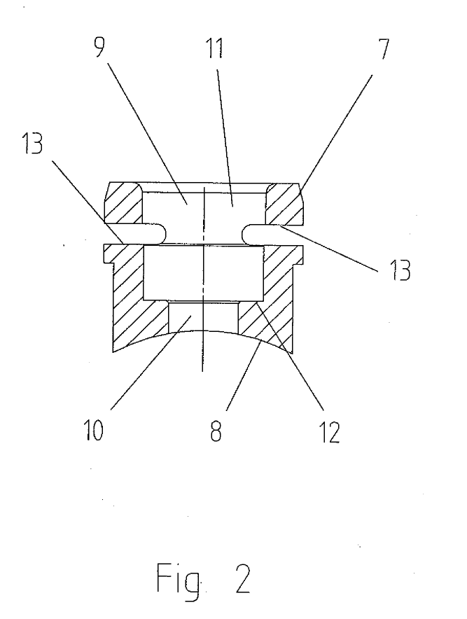

FIG. 2 shows the pressure connection element 7 in cross section, transverse to the axial dimension of the cylinder 1. The pressure connection element 7 is designed as a sleeve-like component and comprises a contact surface 8, by which the pressure connection element 7 rests on the cylinder 1, where the radius of the contact surface 8 is essentially the same as the outside radius of the cylinder 1.

A bore 11, which is divided into a first bore section 9 and a second bore section 10, extends through the pressure connection element 7, where the second bore section, i.e., the section near the contact surface 8, comprises a smaller inside diameter than the first bore section 9 of the bore 11. As a result, a shoulder 12 is formed in the bore 11. In the first bore section 9 of the bore 11, at least one but preferably two slots 13 are formed, which extend through the wall of the pressure connection element. 7.

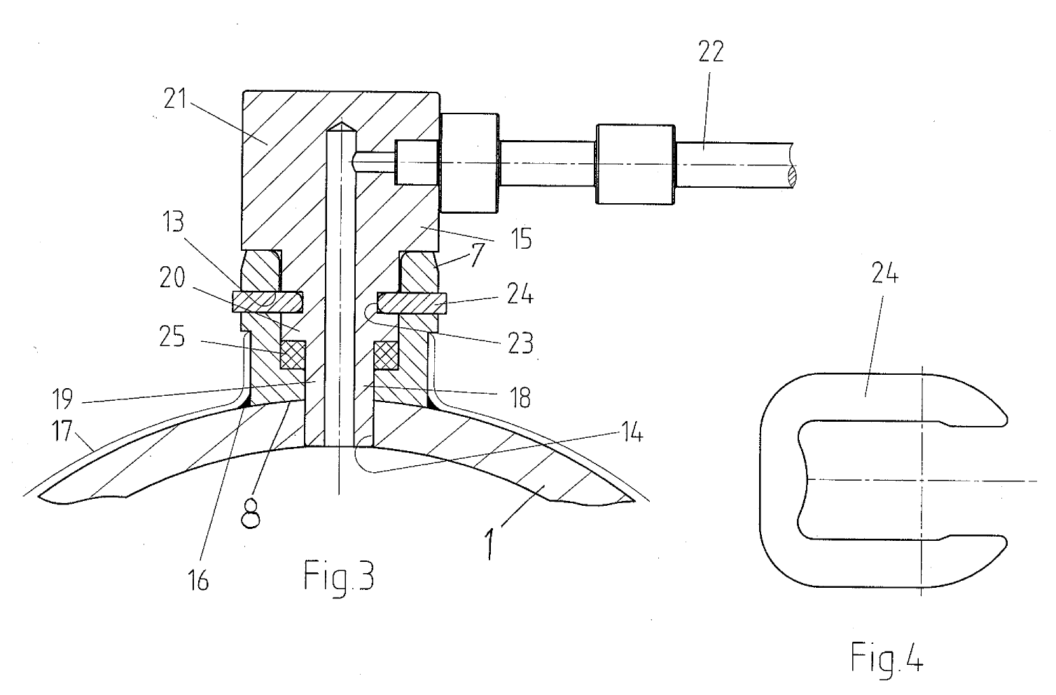

FIG. 3 shows the pressure connection element 7 after it has been welded to the cylinder 1. The pressure connection element 7 is arranged concentrically over a bore 14 in the cylinder 1, so that a pressure line connector 15 introduced into the pressure connection element 7 projects through the bore 11 of the pressure connection element 7 and into the bore 14 in the cylinder 1.

A radially and circumferentially oriented welding seam 16, preferably produced by laser welding, surrounds the pressure connection element 7 near the contact surface 8. A coat of varnish 17 is applied to the cylinder 1 and covers the seam 16 and at least part of the pressure connection element 7. The pressure connection element 7 is preferably made of a non-corroding material such as high-grade steel and is not provided with a coat of varnish 17 in the area of the slots 13.

The pressure line connector 15 comprises a hollow shaft 18. The shaft 18 comprises in turn a first shaft section 19, the outside diameter of which is essentially the same as the inside diameter of the bore 11 of the pressure connection element 7 in the area of the second bore section 10 and of the bore 14 in the cylinder 1, and a second shaft section 20, the outside diameter of which is essentially the same as the inside diameter of the bore 11 of the pressure connection element 7 in the area of the first bore section 9. Following the second shaft section 20 is a connector head 21, from which a pressure line 22 extends in the radial direction, this line being connected in a suitable manner to the connector head 21.

The second shaft section 20 comprises on its lateral surface a radially-oriented circumferential groove 23. As shown in detail in FIG. 4, an essentially C-shaped retaining clip 24 is pushed into the slots 13, this clip engaging in the groove 23 in the pressure line connector 15.

A sealing ring 25, which is pushed onto the first shaft section 19, lies between the shoulder 12 and the second shaft section 20. The sealing ring 25 can be an O-ring, which is pressed by the second shaft section 20 against the shoulder 12 and thus is pretensioned. Alternatively, a rectangular ring can be used, which is pushed by the pressure prevailing in the cylinder 1 against the second shaft section 20.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A pressure medium connection for a cylinder comprising:
a pressure line connector; and
a pressure connection element comprising:
a body having a first end and a second end;
a contact surface arranged at the first end of the body configured to contact an outside surface of the cylinder;
a bore through the body from the first end to the second end, the pressure line connector being insertable into the bore, the bore comprising:
a first bore section having a first diameter;
a second bore section having a second diameter, the first diameter being larger than the second diameter; and
a shoulder at the transition from the first bore section to the second bore section; and
at least one slot formed in an outer wall of the body, at least a portion of the slot extending through the outer wall to the bore.

2. The pressure medium connection according to claim 1, wherein the contact surface comprises a radius configured to match an outside radius of the cylinder.

3. The pressure medium connection according to claim 1, wherein the pressure line connector comprises a hollow shaft having a first shaft section and a second shaft section.

4. The pressure medium connection according to claim 3, wherein the first shaft section has an outside diameter that is substantially equal to the second diameter of the second bore section and a bore in the cylinder.

5. The pressure medium connection according to claim 4, wherein the second shaft section comprises an outside diameter that is substantially equal to the diameter of the first bore section.

6. The pressure medium connection according claim 5, wherein the pressure line connector further comprises a connector head configured for connection to a pressure line, the connector head coupled to the second shaft section.

7. The pressure medium connection according to claim 6, wherein the second shaft section of the pressure line connector further comprises a circumferential groove in its lateral surface.

8. The pressure medium connection according to claim 7, further comprising a substantially C-shaped retaining clip configured to simultaneously engage both the circumferential groove in the pressure line connector and the at least one slot formed in the outer wall of the body when the pressure line connector is inserted in the bore of the body.

9. The pressure medium connection according to claim 8, further comprising a sealing ring configured for placement on the first shaft section, such that when the pressure line connector mates with the pressure connection element the sealing ring lies between the shoulder and the second shaft section.

10. The pressure medium connection according to claim 9, wherein the sealing ring is an O-ring.

11. The pressure medium connection according to claim 9, wherein the sealing ring is a plain compression ring, which is pushed by a cylinder pressure against the second shaft section.

12. The pressure medium connection according to claim 1, wherein a radially-oriented circumferential welding seam surrounds the pressure connection element near the contact surface.

13. The pressure medium connection according to claim 12, wherein the welding seam is created by laser welding.

14. The pressure medium connection according to claim 12, further comprising a coat of varnish applied to the cylinder to cover the welding seam and at least part of the body.

15. The pressure medium connection according to claim 1, wherein the pressure connection element is made of non-corroding material and is not provided with a coat of varnish in the area of the slots.

16. A piston-cylinder unit with comprising the pressure medium connection according to claim 1.

17. The pressure medium connection according to claim 10, wherein the O-ring is pretensioned by being pressed by the second shaft section against the shoulder.

18. The pressure medium connection according to claim 14, wherein the pressure connection element is made of non-corroding material and is not provided with a coat of varnish in the area of the slots.
